(19) United States
(12) Patent Application Publication
(10) Pub. No.: US 2026/0369853 A1
(43) Pub. Date: Nov. 19, 2026

(54) Battery Cell

(71) Applicant: SK On Co., Ltd., Seoul (KR)

(72) Inventor: Yea-Eun KIM, Daejeon (KR)

(21) Appl. No.: 19/515,527

(22) PCT Filed: Jul. 31, 2024
(86) PCT No.: PCT/KR2024/011283

§ 371 Date: Mar. 2, 2026

(30) Foreign Application Priority Data
Sep. 4, 2023 (KR) 10-2023-0116984

(51) Int. Cl. H01M 50/636; H01M 50/682

(52) U.S. Cl. CPC H01M 50/636; H01M 50/682

(57) ABSTRACT

According to an embodiment of the present disclosure, the provided battery cell comprises: an electrode assembly; a container accommodating the electrode assembly in an inner space and including a liquid injection port through which a fluid passes; and a valve cap which closes the liquid injection port, and which uses the difference between the internal pressure of the container and the external pressure of the container so as to rotate at a predetermined angle in one direction, thereby opening the liquid injection port.

### TECHNICAL FIELD

The present disclosure relates to a battery cell.

### BACKGROUND ART

Secondary batteries (battery cells), unlike primary batteries, offer the convenience of rechargeability, making them a popular power source for various mobile devices, electric vehicles, and the like.

Such secondary batteries may have a structure in which the electrode assembly, formed by stacking a cathode plate, an anode plate, and a separator or by winding all thereof into the form of a roll, is housed within a case.

Meanwhile, the case may be equipped with a liquid injection port to allow electrolyte injection during the manufacturing process, and a filler cap to close the liquid injection port and prevent foreign objects from entering.

During the secondary battery manufacturing process, the filler cap should be attached before electrolyte injection to prevent foreign objects from entering. The filler cap should then be removed to open the liquid injection port for the electrolyte injection, and the filler cap should then be reattached after electrolyte injection to close the liquid injection port, thereby complicating the manufacturing process.

That is, in the past, it was necessary to open or close the liquid injection port individually during the manufacturing process.

### DISCLOSURE OF INVENTION

### Technical Problem

During the manufacturing process, liquid injection ports need to be individually opened or closed before and after the injection process.

An aspect of the present disclosure is to provide a battery cell in which the liquid injection port opens due to a pressure differential inside or outside the container.

### Solution to Problem

According to an aspect of the present disclosure, a battery cell includes an electrode assembly; a container accommodating the electrode assembly in an inner space and including a liquid injection port through which a fluid passes; and a valve cap structured to close the liquid injection port, and to rotate in one direction at a predetermined angle due to a difference between internal pressure of the container and external pressure of the container to open the liquid injection port.

According to an embodiment, the valve cap may include a valve cover having a valve hole communicating with the liquid injection port and inserted into the liquid injection port; and a valve body rotatably provided in the valve hole and structured to open and close the valve hole.

According to an embodiment, the valve body may include a valve disc having a shape corresponding to the valve hole and a valve shaft disposed across the valve hole and providing a rotational axis to the valve disc.

According to an embodiment, the valve shaft may divide the valve hole into a first valve hole and a second valve hole.

According to an embodiment, the valve disc may include a first disc disposed on one side of the valve shaft and a second disc disposed on the other side, and the first disc may be structured to open and close the first valve hole, and the second disc may be structured to open and close the second valve hole.

According to an embodiment, the first disc and the second disc may be structured to rotate together relative to the valve shaft, such that the first valve hole and the second valve hole open and close together.

According to an embodiment, the valve cap may further include a valve stopper preventing the valve body from rotating in the other direction, and the valve body may be structured to rotate in only one direction when fluid passes through the liquid injection port.

According to an embodiment, the valve stopper may be structured to support either an upper portion of the first disc or a lower portion of the second disc.

According to an embodiment, the valve cap may include a disc hole formed by penetrating through either the first disc or the second disc and communicating with the liquid injection port; and an auxiliary body structured to close the disc hole, and to rotate at a predetermined angle due to a difference between the internal pressure of the container and the external pressure of the container to open the disc hole.

According to an embodiment, the auxiliary body may include an auxiliary disc having a shape corresponding to the disc hole; and an auxiliary shaft providing a rotational axis to the auxiliary disc, and the auxiliary disc may open the disc hole by rotating about the rotational axis.

According to an embodiment, the disc hole may penetrate through the first disc or the second disc with a cross-sectional area smaller than a cross-sectional area of the first disc or the second disc, and the auxiliary disc may have a cross-sectional area corresponding to an open area of the disc hole.

According to an embodiment, the auxiliary shaft may be provided at an end on one side of the auxiliary disc.

According to an embodiment, the valve cap may support the lower portion on the other side of the auxiliary disc and prevent the lower portion on the other side thereof from moving toward a lower portion of the disc hole.

According to an embodiment, the valve cap may further include a valve stopper supporting an upper portion of the first disc or a lower portion of the second disc, and the valve body and the auxiliary body may rotate only in the same direction.

In addition, according to another aspect of the present disclosure, a battery cell includes an electrode assembly; a container accommodating the electrode assembly in an inner space and including a liquid injection port through which fluid passes; and a valve cap rotatably provided at the liquid injection port to open and close the liquid injection port, wherein the valve cap has an increased area opening the liquid injection port as a difference between internal pressure of the container and external pressure of the container increases.

Above, the solution according to the present disclosure has been described, but this is only an example, and even if other configurations not mentioned herein are added, they should be understood to be included in the present disclosure.

### Advantageous Effects of Invention

According to an aspect of the present disclosure, a battery cell may be provided in which a liquid injection port is opened by a pressure differential inside or outside the container.

### BRIEF DESCRIPTION OF DRAWINGS

FIG. 1 is a perspective view of a battery cell according to an embodiment.

FIG. 2 is an exploded perspective view of a battery cell according to an embodiment.

FIG. 3 is a perspective view of a valve cap according to an embodiment.

FIG. 4 is a view illustrating a valve cap mounted on a liquid injection port.

FIG. 5 is a view illustrating an electrolyte being injected through a liquid injection port according to an embodiment.

FIG. 6 is a view illustrating a gas being discharged through a liquid injection port according to an embodiment.

FIG. 7 is a perspective view of a valve cap according to another embodiment.

FIG. 8 is a view illustrating an electrolyte being injected through a liquid injection port according to another embodiment.

FIG. 9 is a view illustrating a gas being discharged through a liquid injection port according to another embodiment.

### BEST MODE FOR THE INVENTION

Before proceeding to a detailed description of the embodiments, it should be noted that the terms and words used in the following description and claims should not be construed as limited to their conventional or dictionary meanings. Based on the principle that inventors may appropriately define the concepts of terms to best describe their inventions, they should be interpreted with meanings and concepts consistent with the technical spirit of the present disclosure.

Identical reference numbers or symbols in respective drawings represent components or elements that perform substantially the same functions. For convenience of explanation and understanding, the same reference numbers or symbols may be used in different embodiments.

In the following description, the singular expression includes the plural expression unless the context clearly indicates otherwise. Terms such as “comprises,” “configured” or the like are intended to indicate the presence of features, numbers, steps, operations, components, parts, or combinations thereof described in the specification, but should be understood not to preclude the presence or addition of one or more other features, numbers, steps, operations, components, parts, or combinations thereof.

In addition, in the following description, terms such as “top,” “upper,” “lower,” “below,” “side,” “front,” “rear,” and the like are expressed based on the directions illustrated in the drawings, and it is noted in advance that they may be expressed differently if the orientation of the corresponding object changes.

Furthermore, terms including ordinal numbers, such as “first,” “second,” and the like may be used to distinguish between components in the following description and claims. These ordinal numbers are used to distinguish identical or similar components, and the use of these ordinal numbers should not be interpreted as limiting the meaning of the terms. For example, the order of use or disposition or the like of components associated with these ordinal numbers should not be construed as limited by their numbers. If necessary, respective ordinal numbers may be used interchangeably.

Hereinafter, a battery cell according to the present disclosure will be described with reference to the drawings.

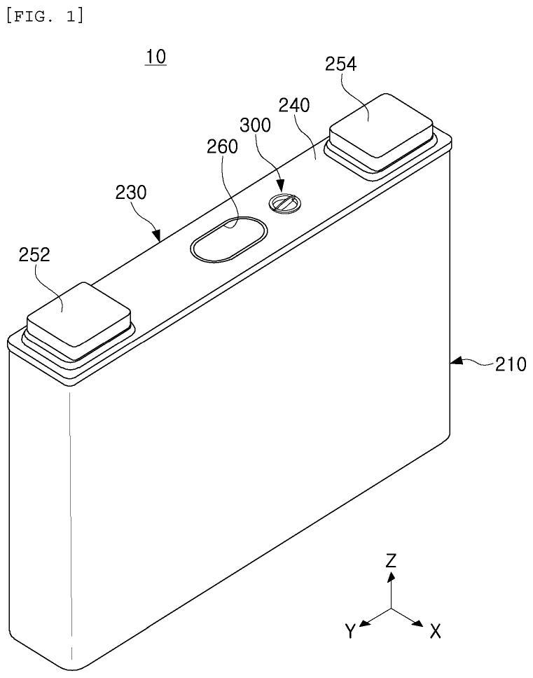

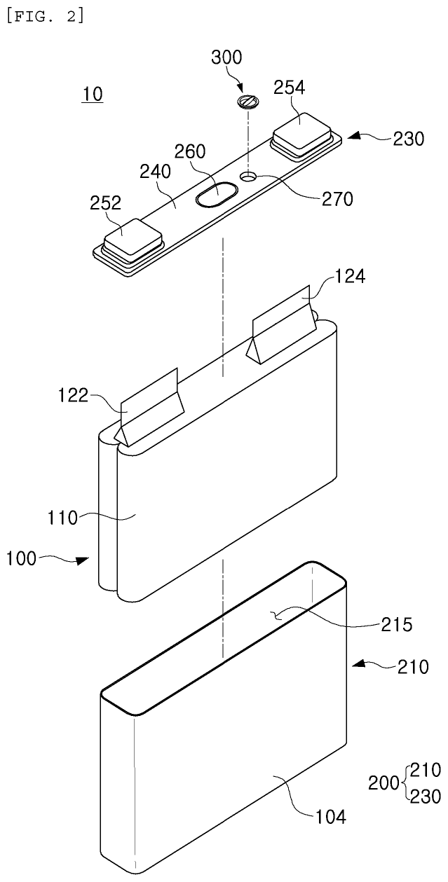

FIG. 1 is a perspective view of a battery cell according to an embodiment, and FIG. 2 is an exploded perspective view of the battery cell according to an embodiment.

Referring to FIGS. 1 and 2 together, a battery cell (10) according to an embodiment of the present disclosure may include an electrode assembly (100), a container (200) that accommodates the electrode assembly (100) in its inner space and includes a liquid injection port (270) through which liquid injected into the inner space passes along an injection direction toward the electrode assembly (100), and a valve cap (300) configured to close the liquid injection port. Here, the valve cap closes the liquid injection port (270) and may open the liquid injection port (270) by rotating under internal or external pressure of the container (200).

Meanwhile, the battery cell (10) of the present disclosure is depicted as a prismatic cell in the drawing, but this is for facilitating understanding. The present disclosure is not limited to the external appearance or battery type shown in the drawing. Cylindrical cells, pouch-type cells, and the like may also be considered within the scope of the present disclosure as long as they have a liquid injection port (270) through which electrolyte and the like, and other fluids may be introduced.

The electrode assembly (100) may be formed by sequentially stacking a plurality of electrode plates in a predetermined direction. In detail, the electrode assembly (100) may be formed by sequentially stacking one or more cathodes coated with a cathode active material, one or more anodes coated with an anode active material, and a separator disposed therebetween.

The separator may be configured to prevent electrical short-circuiting between the cathode plate and the anode plate and to facilitate ion flow. For example, the separator may include a porous polymer film or porous non-woven fabric.

Additionally, the electrode assembly (100) may be configured as a jelly roll type, formed by winding in a predetermined direction. In detail, based on the drawing, a plurality of electrode plates may be stacked in the thickness direction (X-axis direction), and the electrode tabs may protrude in a height direction (Z-axis direction) perpendicular thereto, to be electrically connected to the cap assembly (230) described below. However, the electrode assembly (100) of the present disclosure is not limited thereto and should be interpreted to include any structure in which the cathode, separator, and anode are sequentially and repeatedly stacked, such as a stacking type, a zigzag folding type, a stack-folding type, or the like.

The electrode assembly (100) may be configured as a plurality of electrode plates stacked in a predetermined direction, as shown in the drawing. However, the battery cell (10) of the present disclosure is not limited by the number of electrode assemblies (100) or the winding configuration.

The electrode assembly (100) may include a cell body (110) in which a plurality of electrode plates (not shown) are stacked, and cell tabs (122, 124) protruding from the cell body (110) and electrically connected to electrode terminals (252, 254) described below.

The container (200) may accommodate the electrode assembly (100) in its inner space. The container may include a case (210) having an opening (215) for accommodating the electrode assembly (100), and a cap assembly (230) coupled to the case to cover the opening (215).

In an embodiment, the container (200) is provided in a hexahedral shape, but is not necessarily limited thereto, as long as it is the structure in which the case (210) for accommodating the electrode assembly and the cap assembly (230) covering the case (210) may be provided. For example, if the battery cell (10) is a cylindrical cell, the container may be provided in a cylindrical shape.

In addition, the container (200) may be provided with a liquid injection port (270) through which liquid injected into the container passes. The liquid injection port (270) may be formed in either the case (210) or the cap assembly (230), which will be described later, but considering the rigidity of the case and the position of the venting portion (260), may be provided in the cap assembly (230).

The liquid injection port (270) may be disposed to face the electrode assembly (100) along the injection direction.

Here, the “injection direction” refers to the direction in which the electrode assembly (100) and the liquid injection port (270) face each other, and may refer to the penetration direction of the liquid injection port (270) or the height direction (Z-axis direction) of the electrode assembly (100).

Meanwhile, the “liquid” described in the present disclosure may include any fluid introduced through the liquid injection port (270). In detail, the “liquid” described in the present disclosure may refer to an electrolyte impregnated into the electrode assembly (100), but is not necessarily limited to an electrolyte. Any fluid which may be injected through the liquid injection port (270) and of which flow direction may be guided by the injection guide (300), described later, should be understood to fall within the present disclosure.

The case (210) has a receiving space formed therein to accommodate the electrode assembly (100). Furthermore, the case (210) may accommodate the liquid injected through the liquid injection port (270).

The case (210) may protect the electrode assembly (100) from the external environment and maintain the external appearance of the battery cell (10).

For example, the case (210) may include a metal material such as steel, aluminum alloy, stainless steel or the like to ensure sufficient rigidity.

However, the material of the case (210) in the present disclosure is not specifically limited, and it should be understood that any material capable of maintaining the external appearance of the battery cell (10) to the extent that the electrode assembly (100) may be accommodated therein is not particularly limited.

In an embodiment, the case (210) has an opening formed in one side, allowing the electrode assembly (100) to enter the case. On the other hand, while the opening (215) is described as being formed in one side in one embodiment, the case (210) according to the present disclosure is not limited thereto. For example, in the case of a bidirectional battery cell (10) in which the cell tabs (122, 124) of the electrode assembly (100) protrude in both directions, the openings (215) may be formed on both sides of the case (210).

The cap assembly (230) is provided to cover the opening and may be coupled to the case (210). The cap assembly (230) may include a cap plate (240) that covers the opening (215) of the case (210) and seals the inner space of the case (210).

The cap plate (240) may be formed of a material with sufficient strength to ensure mechanical rigidity, and may be formed of the same material as the case (210) to distribute shock from the case (210).

Furthermore, the cap assembly (230) may be provided with electrode terminals electrically connected to the cell tabs (122, 124) of the electrode assembly (100) housed in the inner space of the case (210). The electrode terminals (252, 254) may include a first electrode terminal (252) that contacts the first cell tab (122) of the electrode assembly (100) and a second electrode terminal (254) that contacts the second cell tab (124) of the electrode assembly (100).

The first cell tab (122) and the second cell tab (124) may be provided with different electrical polarities, and in this case, the first electrode terminal (252) and the second electrode terminal (254) may also be provided with different electrical polarities.

Meanwhile, while the drawing illustrates that the first electrode terminal (252) and the second electrode terminal (254) may be formed by protruding in the same direction, the present disclosure is not limited thereto. In the case of the bidirectional battery cell described above, the first electrode terminal (252) may be disposed on one side of the case (210), and the second electrode terminal (254) may be disposed on the other side of the case (210), to face each other.

According to an embodiment, the cap assembly (230) may include a venting portion (260) configured to discharge gas generated within the inner space of the case (210).

The venting portion (260) may include a venting hole (261) formed by penetrating through the cap assembly (230) and a venting cap (263) configured to close the venting hole (213) and rupture at a predetermined pressure. If flames and gas are generated inside the container (200) due to damage to the electrode assembly (100) or the like, the venting cap (263) ruptures, allowing the gas to escape to the outside of the case (210) through the venting hole (261), thereby preventing the battery cell (10) from exploding.

According to an embodiment of the present disclosure, the liquid injection port (270) described above may be provided in the cap plate (240) of the cap assembly (230). In detail, the cap assembly (230) may include a liquid injection port (270) formed by penetrating the cap plate (240) to allow liquid to be injected into the inner space of the case.

The liquid injection port (270) may be formed to penetrate the cap plate (240) in the thickness direction (the direction facing the electrode assembly (100), for example, the injection direction or Z-axis direction). Accordingly, liquid injected through the liquid injection port (270) may pass through the cap plate and be injected into the internal space of the case (210).

Meanwhile, while the liquid injection port (270) in the drawing is depicted as penetrating the cap plate (240), the liquid injection port (270) of the present disclosure is not limited thereto. Any liquid injection port (270) may be formed to penetrate the container (200) or case (210) housing the electrode assembly (100) so that liquid may be injected therein.

Based on the injection direction (Z-axis direction, facing the electrode assembly (100)) along which liquid is injected through the liquid injection port (270), the liquid injection port (270) and the electrode assembly (100) may be disposed so that at least a portion of the liquid injection port (270) overlaps with each other.

Here, “overlapping” means that the electrode assembly (100) is disposed so that the projection of the liquid injection port (270) along the injection direction overlaps with the surface of the electrode assembly (100).

That is, since the electrode assembly (100) fills as much of the inner space of the case (210) as possible for energy efficiency, the liquid injection port (270) and the electrode assembly (100) may be disposed to overlap each other in the injection direction described above.

Meanwhile, the battery cell manufacturing process may include a filling process of injecting electrolyte into the battery cell through the liquid injection port (270) and a degassing process of discharging gases generated during the battery cell charging and discharging process through the liquid injection port (270).

However, to prevent foreign objects from entering the liquid injection port (270) during the battery cell manufacturing process, the liquid injection port (270) should be covered in processes that do not require fluid movement through the liquid injection port (270), such as the filling process, degassing process or the like.

At this time, during the battery cell manufacturing process, the liquid injection port (270) should be sealed, but opened during the filling process and degassing process, and resealed after the filling process or degassing process is completed, thereby lowering battery cell production efficiency.

According to the present disclosure, a valve cap (300) that covers the liquid injection port (270) and rotates to open the liquid injection port (270) based on the pressure differential inside or outside the container (200), for example, the pressure differential generated during the filling or degassing process, may be included.

Thus, if the valve cap (300) is installed on the liquid injection port (270) during the battery cell manufacturing process, there is no need for a worker to separately remove the valve cap (300) and open the liquid injection port (270) during the subsequent filling or degassing process. This simplifies the manufacturing process and increases production efficiency.

Meanwhile, the present disclosure uses the filling and degassing processes as examples to explain the operation of the valve cap (300). However, this is merely for the purpose of facilitating understanding and is not limited to the filling and degassing processes.

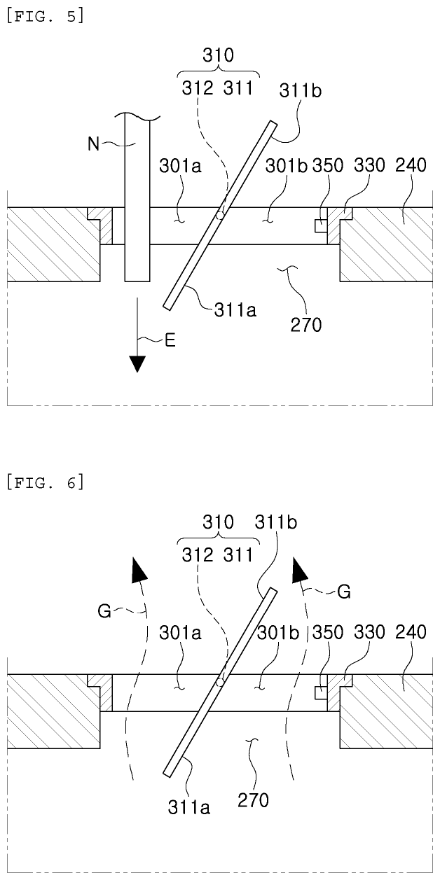

In detail, the valve cap (300) should be understood to fall within the present disclosure if it is structured to open at least part of the liquid injection port (270) while rotating, such as when fluid is introduced into the container (200), when fluid is discharged from the inside of the container (200), when an external force, such as a pouring nozzle (N, see FIG. 5) described below or the like, is applied, or the like. In other words, if the valve cap (300) rotates due to the difference between the internal and external pressures, it should be understood to fall within the present disclosure.

Here, the external pressure may be not only atmospheric pressure, but also the external force of the pouring nozzle (N) or the liquid pressure of the electrolyte (E). The internal pressure may be the pressure caused by gas (G) generated within the container (200).

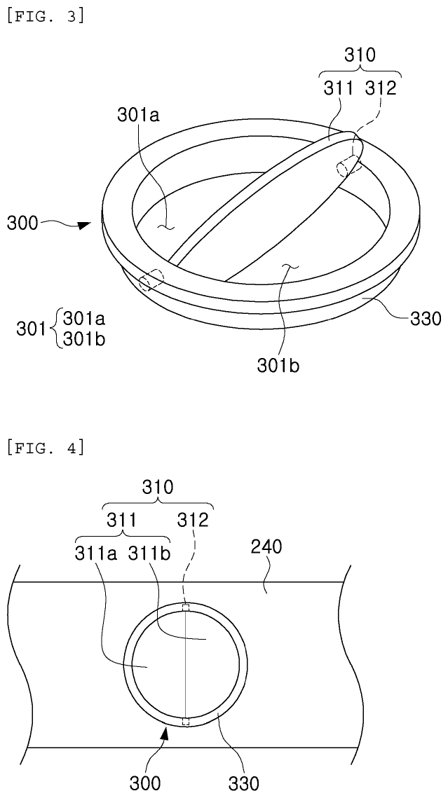

FIG. 3 is a perspective view of a valve cap according to an embodiment, and FIG. 4 is a view illustrating the valve cap mounted on a liquid injection port.

Referring to FIGS. 3 and 4, a valve cap (300) according to an embodiment of the present disclosure may be inserted into a liquid injection port (270) provided on a cap plate (240) to close the liquid injection port (270).

Meanwhile, in the present disclosure, “the valve cap (300) closes or blocks the liquid injection port (270)” means not only sealing the liquid from passing through, but also covering the liquid injection port (270) to a degree that prevents foreign objects from entering the container (200), even if the sealing is not complete.

That is, the valve cap (300) may reduce the open area of the liquid injection port (270) to prevent foreign objects from entering.

Additionally, in the present disclosure, the valve cap (300) is sufficiently capable of controlling the amount of fluid passing through the liquid injection port (270) by changing the open area of the liquid injection port (270) by rotating according to the difference in internal and external pressure of the container (200).

The valve cap (300) may include a valve body (310) provided in the liquid injection port (270). The valve body (310) may include a valve disc (311) rotatably provided in the liquid injection port (270) and a valve shaft (312) disposed to cross the liquid injection port (270) and provide a rotational axis to the valve disc (311).

The valve cap (300) may further include a valve cover (330) that couples the valve body (310) to the liquid injection port (270). The valve cover (330) may be connected to the cap plate (240) by being inserted into the liquid injection port (270). For example, the valve cover (330) may accommodate a valve body (310) including a valve hole (301) communicating with the liquid injection port (270).

In an embodiment, a valve shaft (312) is inserted by penetrating through the inner peripheral surface of the valve cover (330) while crossing the valve hole (301), thereby providing a rotational axis for the valve disc (311). At this time, the valve hole (301) may be divided into a first valve hole (301a) and a second valve hole (301b) based on the extension direction of the valve shaft (312).

The valve hole (301) may be understood as being divided into a first valve hole (301a) and a second valve hole (301b) based on a virtual line extending in the direction transverse to the valve shaft (312).

Meanwhile, in the drawing, the valve shaft (312) is configured to protrude from the valve disc (311) to face each other and be inserted into the valve cover (330). However, the present disclosure is not limited to this configuration. The valve shaft (312) of the present disclosure may be configured to penetrate the valve disc (311) and cross the liquid injection port (270) or valve hole (301).

The valve disc (311) may be configured to open and close the liquid injection port (270), specifically the valve hole (301) of the valve cover (330), while rotating around the valve shaft (312). The valve disc (311) may be configured to have a corresponding shape to close the valve hole (301).

Meanwhile, since the valve hole (301) is connected to the liquid injection port (270), the valve disc (311) closing the valve hole (301) may be understood as meaning the valve disc (311) opening and closing the liquid injection port (270). (See FIGS. 5 and 6)

The valve disc (311) may be divided into two regions based on the axial direction (the extension direction of the valve shaft (312)).

In detail, referring to FIG. 4, the valve disc (311) may include a first disc (311a) disposed on one side relative to the valve shaft (312) to open and close the first valve hole (301a), and a second disc (311b) disposed on the other side to open and close the second valve hole (301b). The first disc (311a) and the second disc (311b) may be provided in shapes corresponding to the first valve hole (301a) and the second valve hole (301b), respectively.

That is, the valve disc (311) may be divided into the first disc (311a) and the second disc (311b) by the valve shaft (312).

Here, “divided” may mean that the valve disc (311) is divided into the first disc (311a) disposed in the first through-hole (301a) and the second disc (311b) disposed in the second through-hole (301b), based on a virtual line traversed by the valve shaft (312).

The valve disc (311) normally blocks the valve hole (301) communicating with the liquid injection port (270). However, during a filling process, a degassing process or the like, the valve disc (311) may rotate at a predetermined angle relative to the valve shaft (312) due to the difference between the internal and external pressures of the case (210), thereby opening the liquid injection port (270).

For example, the first disc (311a) and the second disc (311b) are formed integrally and may rotate together to open and close the first valve hole (301a) and the second valve hole (301b).

The valve cover (330) may be provided to surround the valve body (310). The valve cover (330) may be fitted to the liquid injection port (270) to close the gap between the valve disc (311) and the liquid injection port (270) (see FIGS. 5 and 6).

The valve body (310) is rotatably mounted on the valve cover (330). The valve cover (330) is fitted onto the liquid injection port (270) so that the valve hole (301) and the liquid injection port (270) are in communication with each other, while the valve cap (300) is mounted on the cap plate (240).

Furthermore, in an embodiment, the valve cap (300) may further include a valve stopper (350) provided to prevent rotation of the valve disc (311) (See FIGS. 5 and 6). The valve stopper (350) may be provided on one lower end of the valve disc (311) to ensure the valve disc 311 to rotate in only one direction. For example, the valve stopper (350) may be provided in a protruding form on the inner peripheral surface of the valve cover (330) to support the lower end of the second disc (311b).

When equipped with a valve stopper (350), the valve disc (311) may open the liquid injection port (270) by rotating only in one direction (counterclockwise in FIGS. 5 and 6) or the other.

Furthermore, the valve shaft (312) may further include an elastic member (not shown) that prevents rotation when the difference between the internal pressure and the external pressure of the case (210) is within a predetermined range.

For example, the elastic member may be a spring. The spring may be provided in a manner wound around the outer peripheral surface of the valve shaft (312) and mounted on the liquid injection port (270) or the valve cover (330). Thus, the spring may provide elastic force to the valve shaft (312) so that the valve shaft 312 is placed in its initial position (the position where the valve disc (311) fully closes the liquid injection port (270)). As a result, the valve disc (311) may close the liquid injection port (270) without rotating in any state other than the filling process or degassing process.

Alternatively, the center of gravity of the valve disc (311) may be arranged to overlap the valve shaft (312), so that the valve disc (311) may block the liquid injection port (270) when the difference between the internal pressure and the external pressure of the case (210) is not large. In this case, the first valve disc (311a) and the second valve disc (311b) of the valve disc (311) may be arranged to have the same cross-sectional area.

Meanwhile, in the present disclosure, the valve cap (300) may be provided with only the valve body (310) on the liquid injection port (270) without the valve cover (330). In this case, the valve shaft (312) may be inserted into the cap plate (240) adjacent to the liquid injection port (270) while crossing the liquid injection port (270).

In addition, the valve cap (300) of the present disclosure is not limited to being used only in the manufacturing process. For example, after the manufacturing process is completed with the valve cap (300) mounted on the battery cell (10) of the present disclosure, the valve cap (300) may be welded to seal the liquid injection port (270). In this case, the valve cap (300) may be provided as a filler cap that seals the liquid injection port (270) without rotating.

That is, in the case of the battery cell (10) of the present disclosure, once the filler cap (300) is mounted on the liquid injection port (270), it is unnecessary to separately open or cover the liquid injection port (270), and it may function as the filler cap on its own, thereby improving production efficiency.

FIG. 5 is a view illustrating an embodiment in which an electrolyte is injected through a liquid injection port, and FIG. 6 is a view illustrating an embodiment in which a gas is discharged through a liquid injection port.

Referring to FIG. 5, the injection nozzle (N) may be inserted into the inner space of the case (210) by passing through the valve hole (301) and the liquid injection port (270) while pressurizing either the first disc (311a) or the second disc (312b). The injection nozzle (N) may be inserted into the inner space of the case (210) to discharge the electrolyte (E).

For example, when the injection nozzle (N) pushes the first disc (311a) of the valve disc (311) blocking the first valve hole (301) downward, the valve disc (311) rotates in one direction around the valve shaft (312), causing the second disc (312b) to move upward, resulting in the first The valve hole (301a) and the second valve hole (301b) may be opened together.

Meanwhile, even if the injection nozzle (N) does not pass through the valve hole (301) and the liquid injection port (270), if the electrolyte (E) is discharged from the outside of the container, the valve disc (311) may rotate due to the hydraulic pressure of the electrolyte (E).

At this time, the electrolyte (E) is injected through the first valve hole (301a) and the internal air is discharged to the outside through the second valve hole (301b), so that the inflow of the electrolyte (E) through the first valve hole (301a) may be performed more smoothly.

Referring to FIG. 6, gas may be generated in the electrode assembly (100) during the charging and discharging process of the battery cell (10), such as the degassing process or the like. When the gas (G) generated within the case (210) reaches a predetermined pressure, the first disc (311a) and second disc (312b) of the valve disc (311) may be pressurized toward the outside due to the difference in pressure with the external pressure of the case (210).

In an embodiment, since a valve stopper (350) is provided at the lower end of the second disc (311b), even if the pressure applied to the first disc (311a) is temporarily greater than the pressure applied to the second disc (311b), the valve disc (311) does not rotate in the other direction (clockwise in the drawing). Ultimately, the second disc (311b) is pushed outward by the internal pressure of the case (210), causing the valve disc (311) to rotate only in one direction (counterclockwise in the drawing).

That is, according to an embodiment, the valve disc (311) may only rotate in one direction during the filling process, in which fluid is introduced into the case, and the degassing process, in which fluid is discharged outside the case.

When the valve disc (311) rotates in one direction, both the first valve hole (301a) and the second valve hole (301b) are opened, allowing the gas (G) inside the case (210) to be dispersed and discharged through the first valve hole (301a) and the second valve hole (301b).

Meanwhile, although the present disclosure described the valve stopper (350) as being disposed at the lower end of the second disc (311b), this is only an embodiment, and the valve stopper (350) may be configured to support the valve disc (311) so that it rotates in only one or the other direction. For example, the valve stopper (350) may be disposed on the upper end of the first disc (311a) so that the valve disc (311) rotates in only one direction.

However, since the valve stopper (350) is disposed on the lower end of the other side of the valve disc (312), the valve disc (312) may rotate only in one direction, with the other side moving away from the liquid injection port (270), thereby opening both the first valve hole (301a) and the second valve hole (301b).

Meanwhile, the valve body (310) rotates due to the pressure differential between the inside and outside of the case (210), thereby changing the open area of the liquid injection port (270).

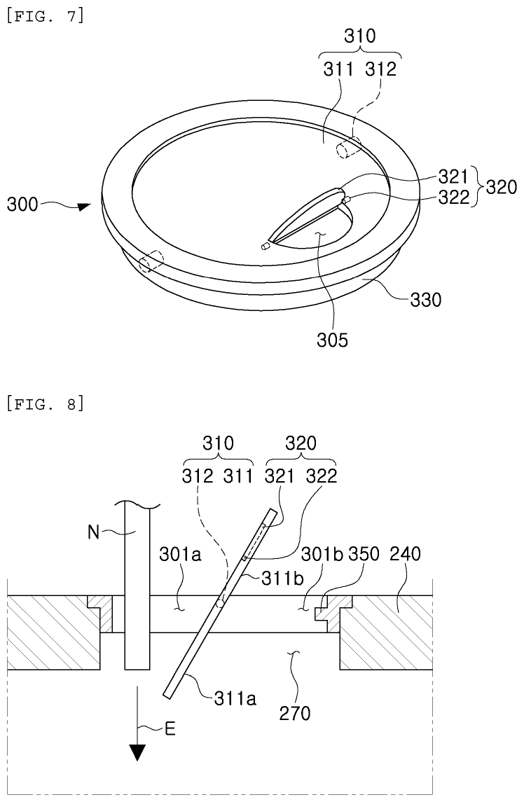

In detail, as the pressure differential between the internal and external pressures of the case (210) increases, the valve body (310) rotates at a greater angle in one direction, thereby increasing the open area of the liquid injection port (270). This also applies to the auxiliary body (320, see FIG. 7) described below.

FIG. 7 is a perspective view of a valve cap according to another embodiment.

According to another embodiment of the present disclosure, the valve cap (300) may include an auxiliary disc (313) attached to the valve disc (311). Meanwhile, description of the other embodiment will be omitted, omitting any overlapping details with the above-described embodiment.

Referring to FIG. 7, the valve cap (300) according to another embodiment of the present disclosure may include an auxiliary body (320) equipped with an auxiliary disc (321) rotatably attached to the valve disc (311) to open and close a portion of the valve disc (311), and an auxiliary shaft (322) providing a rotational axis to the auxiliary disc (321).

The auxiliary body (320) may be provided on either the first disc (311a) or the second disc (311b).

For example, the auxiliary disc (321) may be provided on the second disc (311b), and the auxiliary shaft (322) may be rotatably supported on the second disc (311b). At this time, the auxiliary disc (321) may be provided as a part of the second disc (311b) and may be configured to open and close a portion of the second disc (311b) while rotating around the auxiliary shaft (322).

Here, the portion where a portion of the first disc (311a) or the second disc (311b) is opened and closed by the auxiliary body (320) may be referred to as a disc hole (305). The disc hole (305) is connected to the liquid injection port (270), so that when the disc hole (305) is opened, fluid may pass through the liquid injection port (270) toward the inside or outside of the case (210).

Meanwhile, unlike the valve disc (311), which opens the liquid injection port (270) to the first valve hole (301a) and the second valve hole (301b), the auxiliary disc (313) may be configured to open only the disc hole (305). To this end, an auxiliary shaft (314) may be provided at one end of the auxiliary disc.

The auxiliary shaft (322) may be provided using the same principle as the valve shaft (312). For example, the auxiliary shaft (322) may be provided to protrude from an end on one side of the auxiliary disc (321) and be inserted into the valve disc (311).

However, unlike the valve shaft (312), which is provided between one end and the other end of the valve disc (311) to divide the valve hole (301) into two spaces, the auxiliary shaft (322) may be provided at one or the other end of the auxiliary disc (321).

Through this, the auxiliary shaft (322) does not divide the disc hole (305) into two spaces, and at least a portion of the auxiliary disc (321) does not move to the lower part of the disc hole (305) when the auxiliary body (320) rotates.

That is, unlike when the valve body (310) rotates, both flow path spaces (the first valve hole 301a and the second valve hole (301b)) are opened, when the auxiliary body (320) rotates, only one flow path space (the disc hole 305) may be opened.

Furthermore, according to another embodiment, an auxiliary stopper (370) may be further included to prevent rotation of the auxiliary body (310) in one direction. (See FIG. 9)

The auxiliary stopper (370), like the valve stopper (350), may support the auxiliary disc (321) so that the auxiliary body (320) rotates in only one direction. For example, the auxiliary stopper (370) may be disposed below the auxiliary disc (321) to support the lower portion of the auxiliary disc (321), thereby allowing the auxiliary disc to rotate in only one direction (counterclockwise in the drawing).

At this time, the auxiliary body (320) may be provided to rotate only in the same direction as the valve body (310).

For example, if the valve stopper (350) supports the upper portion of the first disc (311a) or the lower portion of the second disc (311b), the auxiliary shaft (322) may be positioned close to the first disc (311a), and the auxiliary stopper (370) may be positioned close to the end of the second disc (311b). (See FIG. 9.)

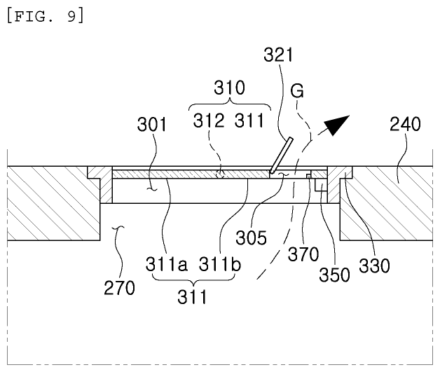

Thus, when the valve body (310) rotates, the pressure applied to the auxiliary body (320) in the direction of opening is reduced, allowing the auxiliary body (320) to reliably maintain the auxiliary disc (305) closed (See FIG. 8.)

However, this is merely an embodiment, and according to the present disclosure, the valve body (310) and the auxiliary body (320) may be configured to rotate in opposite directions.

FIG. 8 is a view illustrating that an electrolyte is injected through a liquid injection port according to another embodiment, and FIG. 9 is a view illustrating that a gas is discharged through a liquid injection port according to another embodiment.

Referring to FIG. 8, the injection nozzle (N) may discharge the electrolyte (E) into the internal space of the case (210) through the valve hole and the liquid injection port (270). At this time, the valve disc (311) may rotate in one direction, opening both the first valve hole (301a) and the second valve hole (301b). Meanwhile, any details overlapping with the previous embodiment will be omitted.

For example, since the lower end of the auxiliary body (320) may be supported by the auxiliary stopper (370), even if the external pressure of the case (210) is greater than the internal pressure and the auxiliary body (320) is pressed inward, the auxiliary body (320) may not rotate.

On the other hand, referring to FIG. 9, if the internal pressure of the case (210) exceeds the external pressure by a predetermined amount or more due to gas (G) generated during the degassing process, or the like, the valve disc (311) and the auxiliary disc (321) are subjected to pressure directed toward the outside of the case (210).

In detail, since the valve stopper (350) and auxiliary stopper (370) are provided, the valve disc (311) and auxiliary disc (321) may only rotate in one direction (counterclockwise in the drawing). Here, the auxiliary body (320) may be configured to rotate at a pressure lower than the pressure at which the valve body (310) rotates. In this case, the valve body (310) does not rotate, and only the auxiliary body (320) rotates in one direction.

That is, when the gas (G) inside the case (210) pressurizes both the first disc (311a) and the second disc (312b) outwardly from the case (210), the auxiliary disc (321) provided on the second disc (312b) rotates in one direction to open the auxiliary hole (305), thereby allowing the gas (G) to be discharged from the inside of the case (210) through the liquid injection port (270).

As the auxiliary body (320) rotates, the difference between the internal and external pressures of the case (210) gradually decreases, so the valve body (310) may not rotate.

At this time, the auxiliary disc (321) may be made larger in cross-sectional area than the second disc (312b) to receive greater pressure than the second disc (312b), thereby improving operational reliability in which the auxiliary disc (321) opens first.

In other words, according to another embodiment of the present disclosure, unlike the first embodiment, when the internal pressure of the case (210) is greater than the external pressure, the liquid injection port (270) may be opened by rotating only the auxiliary body (320).

Meanwhile, since the first valve hole (301a) and the second valve hole (301b) are formed by the valve cover (330) inserted into the liquid injection port (270), their open areas may be smaller than those of the liquid injection port (270). Furthermore, since the disc hole (305) is formed in a portion of the first disc (311a) or the second disc (311b), its open areas may be smaller than those of the first valve hole (301a) and the second valve hole (301b).

While various embodiments of the present disclosure have been described in detail above, the scope of the present disclosure is not limited thereto. It will be apparent to those skilled in the art that various modifications and variations are possible without departing from the technical spirit of the present disclosure as defined in the claims. Certain components of the above-described embodiments may be omitted, and the respective embodiments may be combined with each other.

The above description is merely an example of the application of the principles of the present disclosure, and other configurations may be incorporated without departing from the scope of the present disclosure.

1. A battery cell comprising:
an electrode assembly;
a container accommodating the electrode assembly in an inner space and including a liquid injection port through which a fluid passes; and
a valve cap structured to close the liquid injection port, and to rotate in one direction at a predetermined angle due to a difference between internal pressure and external pressure of the container or external force to open the liquid injection port.

2. The battery cell of claim 1, wherein the valve cap includes,
a valve cover having a valve hole communicating with the liquid injection port and inserted into the liquid injection port; and
a valve body rotatably provided in the valve hole and structured to open and close the valve hole.

3. The battery cell of claim 2, wherein the valve body includes a valve disc having a shape corresponding to the valve hole and a valve shaft disposed across the valve hole and providing a rotational axis to the valve disc.

4. The battery cell of claim 3, wherein the valve shaft divides the valve hole into a first valve hole and a second valve hole.

5. The battery cell of claim 4, wherein the valve disc includes a first disc disposed on one side of the valve shaft and a second disc disposed on the other side,
wherein the first disc is structured to open and close the first valve hole, and the second disc is structured to open and close the second valve hole.

6. The battery cell of claim 5, wherein the first disc and the second disc are structured to rotate together relative to the valve shaft, such that the first valve hole and the second valve hole open and close together.

7. The battery cell of claim 6, wherein the valve cap further includes a valve stopper preventing the valve body from rotating in the other direction, and
the valve body is structured to rotate in only one direction when fluid passes through the liquid injection port.

8. The battery cell of claim 7, wherein the valve stopper is structured to support either an upper portion of the first disc or a lower portion of the second disc.

9. The battery cell of claim 6, wherein the valve cap includes,
a disc hole formed by penetrating through either the first disc or the second disc and communicating with the liquid injection port; and
an auxiliary body structured to close the disc hole, and to rotate at a predetermined angle due to a difference between the internal pressure of the container and the external pressure of the container to open the disc hole.

10. The battery cell of claim 9, wherein the auxiliary body includes,
an auxiliary disc having a shape corresponding to the disc hole; and
an auxiliary shaft providing a rotational axis to the auxiliary disc,
wherein the auxiliary disc opens the disc hole by rotating about the rotational axis.

11. The battery cell of claim 10, wherein the disc hole penetrates through the first disc or the second disc with a cross-sectional area smaller than a cross-sectional area of the first disc or the second disc, and the auxiliary disc has a cross-sectional area corresponding to an open area of the disc hole.

12. The battery cell of claim 11, wherein the auxiliary shaft is provided at an end on one side of the auxiliary disc.

13. The battery cell of claim 12, wherein the valve cap further includes an auxiliary stopper supporting a lower portion on the other side of the auxiliary disc and prevents the lower portion on the other side thereof from moving toward a lower portion of the disc hole.

14. The battery cell of claim 13, wherein the valve cap further includes a valve stopper preventing the valve body from rotating in the other direction so that the valve body rotates only in one direction when the fluid passes through the liquid injection port, and
the valve body and the auxiliary body rotate in the same direction.

15. A battery cell comprising:
an electrode assembly;
a container accommodating the electrode assembly in an inner space and including a liquid injection port through which fluid passes; and
a valve cap rotatably provided at the liquid injection port to open and close the liquid injection port,
wherein the valve cap has an increased area opening the liquid injection port as a difference between internal pressure of the container and external pressure of the container increases.
